(19) United States
(12) Patent Application Publication
(10) Pub. No.: US 2007/0039635 A1
(43) Pub. Date: Feb. 22, 2007

(54) Gas jet apparatus and method

(75) Inventors: John J. Thompson, Williamsville, NY (US); Deborah M. Chess, Morristown, NJ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/207,977

(22) Filed: Aug. 19, 2005

(51) Int. Cl. B08B 7/00

(52) U.S. Cl. 134/42

(57) ABSTRACT

A novel gas jet apparatus and method of using the same to remove particulate matter from the surface of an object, wherein the apparatus utilizes a pressurized fluid comprising at least one of 1,1,1,3,3-pentafluoropropane and trans-1,3,3,3-tetrafluoropropene.

### BACKGROUND

1. Field of Invention

The invention relates generally to a gas jet apparatus and methods of using the same to remove particulates from the surface of an article.

2. Description of Related Art

Dispending a pressurized fluid can be used as a non-contact cleaning method to dislodge and remove particulate matter from a surface. Conventionally, such methods involve dispensing a pressurized fluid from a portable canister, commonly referred to as an “air duster”. As the pressurized fluid is released from the canister it expands and is channeled so as to form a gas jet which then may be directed at a surface of an object to effectively remove particulate matter from that surface.

Air dusters are typically used to remove minute contaminants such as lint, dust, metallic oxide deposits, and other soils. In some cases, pressurized gas is used as a dusting agent as a matter of convenience. In other cases, such as dusting hard-to-reach areas or dusting objects with delicate surfaces, the use of pressurized gas is critical. For example, air dusters can remove particulate matter from the crevices of certain devices, such as computer keyboards. Air dusters can also remove fine particulate matter from delicate surfaces of objects such as integrated circuit boards, media storage and film, optical lenses (such as cameras, scanners, copiers, etc.), laboratory equipment (such as electron microscopes, lasers, etc.) and antiquities. Since the surface to be cleaned is contacted by a gas jet instead of a solid object, such as brush bristles or cloth, the potential for scratching or otherwise damaging the surface is greatly reduced.

The jet stream of conventional air dusters is typically formed from a single composition, such as, for example, 1,1,1,2-tetrafluoroethane (HFC-134a), 1,1-difluoroethane (HFC-152a), air, or carbon dioxide. In some instances, however, they may include additional components such as, for example, antistatic agents.

The fluids of conventional air dusters have several disadvantages. For example, when compressed air or carbon dioxide is used as a dusting fluid, they are stored as compressed gases, instead of as liquefied gases. Compressed gases have the disadvantage of providing fewer blasts per can and required expensive, extremely high-pressure canisters for storage. In addition, as the product is used from the can, the pressure within the can will drop. As a result, the spray characteristics and effectiveness of the product will change throughout its life.

Carbon dioxide and other compressed gas dusters are typically dispensed at relatively high velocities due primarily to their high initial pressures. Liquefied gas dusters utilizing fluids such as HFC-134a and HFC-152a are also dispensed at relatively high velocities due to their high vapor pressures. For example, HFC-134a has a vapor pressure of approximately 86 psia at 70° F. and HFC-152a has a vapor pressure of approximately 77 psia at 70° F. Air dusters utilizing these types of pressurized fluids are commercially available from a variety of sources such as DuPont's DUST-OFF® (HFC-152a), M.G. Chemical's SUPER DUSTER® (HFC-134a), Chemtronics' ULTRAJET® (HFC-134a), and Techspray's ENVI-RO-TECH® 1671 (HFC-134a).

A liquefied gas having a high vapor pressure results in a large pressure differential across the interface between the interior of the canister and the ambient environment, for example at a canister's nozzle. That is, due to the inherent relationship between the pressure and velocity of a flow, when conventional air duster fluids are released from a canister, a gas jet is formed having a very high velocity. When this high velocity jet is directed at a surface, it's kinetic energy is transferred to the surface, and this transfer of energy can adversely affect surfaces that are delicate.

Additionally, the high vapor pressures of these conventional liquefied gases increases the likelihood that a portion of the liquefied gases will be dispensed as vapor spray instead of a gas jet. When these droplets contact the surface of the article to be cleaned, they will quickly vaporize. This vaporization on the surface of an article results in a sudden and pronounced temperature drop due to the latent heat of the fluid. For example, the rapid evaporation of liquid HFC-134a results in a temperature drop of approximately 57° C. In fact, the use of liquefied HFC-134a as freezing agent has been commercialized as evidenced by products such as TECHSPRAY'S ENVI-RO-TECH® 1672 Freezer. This product, like the ENVI-RO-TECH® 1671 duster, utilizes 100% HFC-134a, but dispenses the HFC-134a as a vapor spray instead of a gas jet. Unfortunately, the rapid drop in temperature produced by the evaporating HFC-134a or other conventional air duster fluids can result in the formation of frost on the surface being cleaned. These small areas of frost can crack or otherwise damage fragile surfaces such as electronic and optical equipment and such dangers have prompted some manufacturer's of such equipment to issue warnings against the use of air dusters during cleaning and maintenance operations.

Applicants have discovered methods and products which have the ability, in preferred form, to overcome these and other shortcomings of conventional air dusters.

### SUMMARY OF THE INVENTION

The present invention is directed to cleaning methods and devices, such as air dusters, which utilize a pressurized fluid with beneficial properties for such applications. For example, in preferred embodiments, the fluid of the present invention has, at ambient temperatures, a relatively low vapor pressure, particularly in relation to the vapor pressures of conventional air duster fluids. Accordingly, one aspect of the present invention resides in applicants' discovery that 1,1,1,3,3-pentafluoropropane (HFC-245fa), trans-1,3,3,3-tetrafluoropropene (HFO-1234ze), and mixtures of at least one of these with one or more other compounds, are uniquely suited for use as pressurized fluids in low-pressure air dusters. Air dusters that utilize these low vapor-pressure fluids generally do not exerted as much force upon a surface to be cleaned (as compared to conventional air duster fluids), and thereby reduce the risk of damage to surfaces. In addition, liquefied gases having lower vapor pressures are less likely to produce vapor sprays when dispensed from canisters and therefore are less likely to create damaging frost on the surface to be cleaned.

Accordingly, a first aspect of the present invention is a dusting apparatus having a pressurized fluid comprising HFC-245fa, HFO-1234ze, or a mixture of at least one of these with one or more other compounds, and a mechanism for converting the pressurized fluid into a gas jet. In a preferred embodiment of this aspect of the invention, a gas jet apparatus is provided having a sealed canister, a valve system, and a pressurized fluid comprising at least one of HFC-245fa and HFO-1234ze and having a vapor pressure of from about 18 to about 65 psia at 70° F., more preferably from about 18 to about 40 psia at 70° F.

Another aspect of the present invention provides methods for removing particulate substance(s) from a surface of a object by generating a gas jet from a pressurized fluid, wherein the pressurized fluid is HFC-245fa, HFO-1234ze, or a mixture of at least one of these with one or more other compounds, and then directing that gas jet towards the surface so as to dislodge, and preferably remove, the particulate. According a preferred embodiment of this methods, provided are the steps of (a) providing an object having a surface upon which there is a particulate substance; (b) providing a pressurized fluid comprising at least one of HFC-245fa and HFO-1234ze; (c) producing a gas jet from the pressurized fluid; and (d) directing the gas jet toward object's surface. In this way the gas jet can contact the surface with sufficient motive force to dislodge, and preferably blow away, at least a portion of the particulate substance from the object's surface.

### BRIEF DESCRIPTION OF THE DRAWINGS

FIG. 1 shows a cut-away view of one embodiment of a gas jet apparatus according to the present invention.

FIG. 2 is a graph of vapor pressure vs. temperature of HFC-134a, HFC-245fa, and a 95:5 mixture of HFC-134a and HFC-245fa.

FIG. 3 is a graph of vapor pressure vs. temperature of HFC-134a and HFP-123ze.

FIG. 4 is a chart showing the evaporative cooling of 134a, 245fa, and blends thereof.

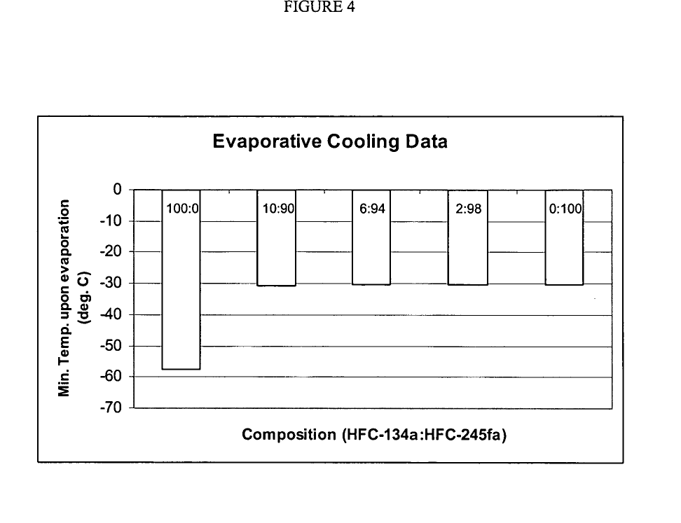

### DETAILED DESCRIPTION OF THE INVENTION

The present invention is directed to a novel, low-pressure dusting apparatus that utilizes a pressurized fluid comprising at least one of HFC-245fa and HFO-1234ze, and methods for using the same. Applicants have found that utilizing HFC-245fa and/or HFO-1234ze in low-pressure air dusters offers several advantages including: (a) low to moderate vapor pressure relative to conventional pressurized fluids used in air dusters, while retaining the ability to produce large volumes of expanded gas; and/or (b) the capability of dispensing virtually all of the product from the air duster canister; and/or (c) environmentally safe; and/or (d) non-flammability.

As used herein the term “pressurized fluid” refers to a gas or liquid under pressure and the term “gas jet” refers to a stream of gas forced under pressure out of a small opening or nozzle. In addition, it will be appreciated that to those skilled in the art that the term “air duster” is used herein in a manner consistent with common usage but is not intended to imply or require that the functioning of the present methods and devices necessarily require “air” to be used. In fact, in most embodiments the movement of air to achieve a dusting or cleaning effect will be indirect or ancillary to the motive force of the preferred fluids hereof, which are not air.

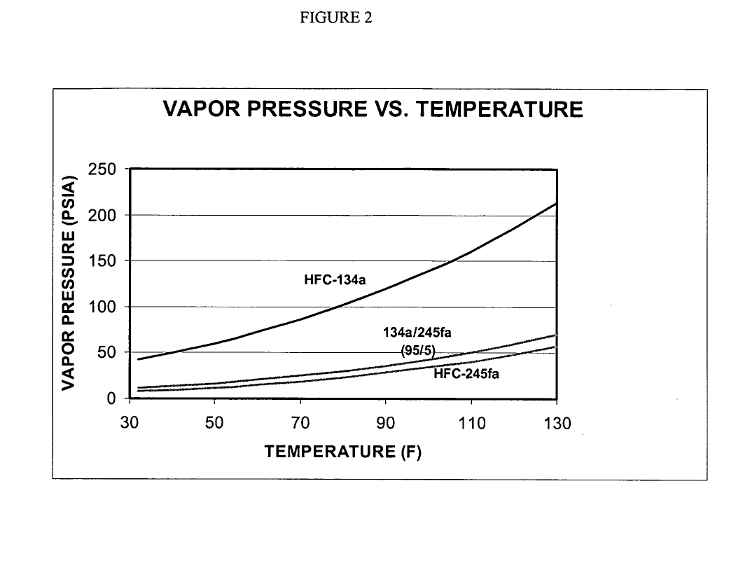

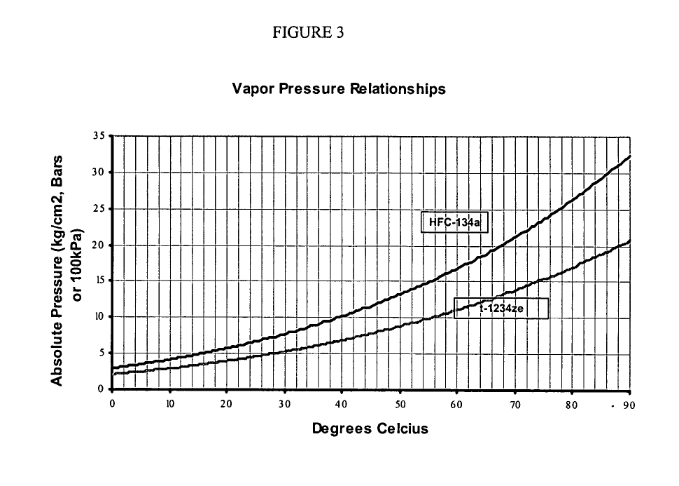

Applicants have discovered that HFC-245fa, HFO-1234ze, and blends containing substantial proportions, and preferably a major proportion, of HFC-245fa, HFO-1234ze, or both, are ideally suited for low-pressure dusters because, in part, they possess relatively lower vapor pressures in comparison to conventional fluids used in air dusters, such as HFC-134a and HFC-152a. (See, for example, the data presented in FIG. 2, showing vapor pressure vs. temperature of HFC-134a, HFC-245fa, and a 95:5 mixture of HFC-134a and HFC-245fa; and the data presented in FIG. 3 showing the vapor pressure vs. temperature of HFC-134a and HFO-1234ze.) The low vapor pressures of HFC-245fa and HFO-1234ze also decreases the probability that a vapor spray will form instead of a gas jet when the fluid is dispensed from a duster, thereby reducing the chance of droplets contacting and evaporating from the surface of the article to be cleaned. As previously stated, such evaporation could result in the formation of frost which, in turn, could damage delicate surfaces. Moreover, as shown in FIG. 3, the evaporative cooling effect of HFC-245fa and blends containing a substantial portion of HFC-245fa is much lower than the evaporative cooling effect of conventional air duster fluids such as HFC-134a. This lower evaporative cooling effect further reduces the likelihood of frost forming on the surface to be cleaned, in the event that droplets of HFC-245fa or HFO-1234ze do contact the surface of an article to be cleaned.

In addition to having a low vapor pressure, liquid HFC-245fa and HFO-1234ze are volatile enough to readily evaporate at ambient pressures. Thus, HFC-245fa and/or HFO-1234ze can be stored as a liquefied gas in an air duster canister and, immediately prior to use, converted into a gas by reducing the canister's internal pressure.

HFC-245fa and HFO-1234ze and certain other hydrofluorocarbons are known to be environmentally acceptable alternatives to chlorofluorocarbons. That is, they are not considered to negatively impact the atmosphere's ozone layer.

HFC-245fa and HFO-1234ze are also known to be non-flammable.

In certain preferred embodiments, the pressurized fluid of the air duster is substantially pure HFC-245fa. That is, the HFC-245fa is not blended with other compositions to form a pressurized fluid.

In certain other preferred embodiments, the pressurized fluid is a blend of HFC-245fa and one or more other compounds. The non-HFC-245fa compounds that comprise the pressurized fluid can have a vapor pressure that is higher or lower than the vapor pressure of HFC-245fa. Preferably, non-HFC-245fa compounds that have a vapor pressure higher (or, have a correspondingly lower boiling point) than that of HFC-245fa will also have a volatility comparable to that of HFC-245fa so that the lower-boiling components and the HFC-245fa will vaporize together. Otherwise, the lower boiling component will be preferentially dispensed from the canister, leaving the higher boiling HFC-245fa behind. In certain embodiments, it may be desirable to use azeotropic fluid blends comprising HFC-245fa.

In certain preferred embodiments, pressurized fluid blends according to the present invention comprise a high ratio of HFC-245fa to the other constituents, including, but not limited to, blends having a HFC-245fa:HFC-134a weight percent ratio of from about 80:20 to about 99:1, and preferably from about 90:10 to about 95:5. The applicability of any particular blend to a dusting operation will depend upon the material, construction, and delicacy of the surface to be cleaned and the nature of the particulate matter to be removed. One skilled in the art could readily determine an appropriate pressurized fluid blend for a specific application without undue experimentation.

In certain preferred embodiments, the pressurized fluid of the air duster is substantially pure HFO-1234ze. That is, the HFO-1234ze is not blended with other compositions to form a pressurized fluid.

In certain other preferred embodiments, the pressurized fluid is a blend of HFO-1234ze and one or more other compounds. The non-HFO-1234ze compounds that comprise the pressurized fluid can have a vapor pressure that is higher or lower than the vapor pressure of HFO-1234ze. Preferably, non-HFO-1234ze compounds that have a vapor pressure higher (or, have a correspondingly lower boiling point) than that of HFO-1234ze will also have a volatility comparable to that of HFO-1234ze so that the lower-boiling components and the HFO-1234ze will vaporize together. Otherwise, the lower boiling component will be preferentially dispensed from the canister, leaving the higher boiling HFO-1234ze behind. In certain embodiments, it may be desirable to use azeotropic fluid blends comprising HFO-1234ze. The applicability of any particular blend to a dusting operation will depend upon the material, construction, and delicacy of the surface to be cleaned and the nature of the particulate matter to be removed. One skilled in the art could readily determine an appropriate pressurized fluid blend for a specific application without undue experimentation.

In a preferred embodiment of the present invention, a dusting apparatus is provided comprising a pressurized fluid that comprises HFC-245fa, HFO-1234ze, or blends containing substantial proportions, and preferably a major proportion, of HFC-245fa, HFO-1234ze, or both; and a mechanism for converting the pressurized fluid into a gas jet. The mechanism for converting the pressurized fluid into a gas jet can be of any type feasible, including, but not limited to, orifices, nozzles, and the like.

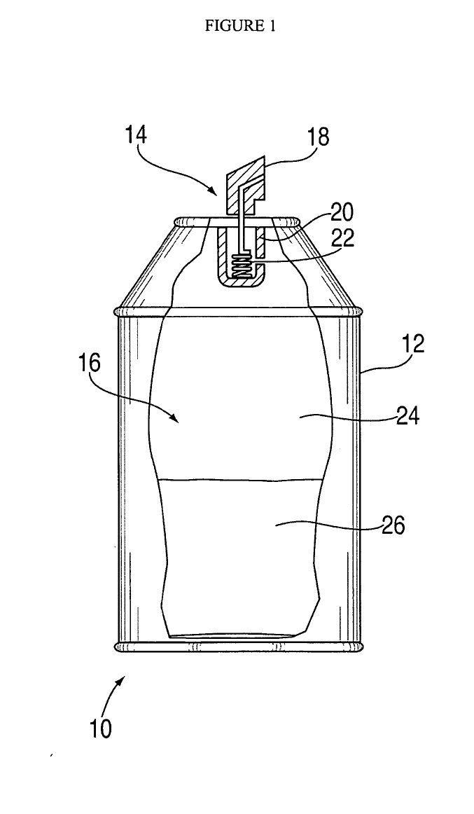

According to certain preferred embodiments, the dusting apparatus of the present invention is a gas jet apparatus comprising a sealed canister, a valve system, and a pressurized fluid having a vapor pressure of from about 20 to about 40 psia at 70° F., wherein said pressurized fluid comprises HFC-245fa, HFO-1234ze, or blends containing substantial proportions, and preferably a major proportion, of HFC-245fa, HFO-1234ze, or both. A particularly preferred embodiment is shown in FIG. 1, wherein an air duster 10 comprises a sealed canister 12, a valve system 14, and a pressurized fluid 16. The pressurized fluid 16 preferably consists of a bottom liquid phase 26 and a top gas phase 24. When a nozzle 18 is depressed, a seal 20 on the canister 12 is temporarily broken thereby allowing a portion of the pressurized gas 24 that accumulates in the top of the canister to exit through the nozzle 18. This egress of gas, in turn, creates a rapid drop of the pressure inside the canister, thereby causing the liquid 26 inside the canister to evaporate creating more gas 24. This process will continue until the pressure inside the canister is in approximate equilibrium with the ambient pressure or until a mechanism, such as a spring 22, returns the valve system to a sealed position.

The present invention also provides for methods of removing a particulate substance from the surface of an object. This method effectively “dusts” the surface by removing minute contaminants such as, for example, lint, dust, metallic oxide deposits, and other soils. This method is particularly well suited for removing particulate matter from objects with delicate surfaces, but may also be used to remove particulate from the surface of any object or to perform any task that could be performed by a conventional air duster.

According to a preferred first step of the present method, an object is provided having a surface upon which there is a particulate substance.

According to a preferred second step, a pressurized fluid comprising HFC-245fa, HFO-1234ze, or blends containing substantial proportions, and preferably a major proportion, of HFC-245fa, HFO-1234ze, or both, is provided at a pressure greater than atmospheric. This pressurized fluid can be provided, for example, from a portable canister. Alternatively, the pressurized fluid can be provided via a tubing or flexible hose that is connected to a fixed source of pressurized HFC-245fa, HFO-1234ze, and blends containing substantial proportions, and preferably a major proportion, of HFC-245fa, HFO-1234ze, or both.

According to a preferred third step, a gas jet is produced from the pressurized fluid. This step can be accomplished by any means known, and preferably is preformed by way of a nozzle or orifice.

In certain highly preferred embodiments of this step, the gas jet is provided by releasing the pressurized fluid from a dusting apparatus preferably comprising a sealed canister, a nozzle, and a valve system. More preferably, the pressurized fluid in the canisters comprises a liquid portion and a gas portion. In such embodiments, the gas jet is produced when a seal on the canister is broken thereby allowing the pressurized gas within the canister to egress through some mechanism, such as a nozzle. This mechanism preferably directs and regulates the flow of the gas jet. As the gas leave the canister, the pressure inside the canister drops. This reduced pressure causes the liquid to evaporate into a gas which, in turn, sustains the gas jet. This process continues until the pressure inside the canister is in approximate equilibrium with the ambient environment or until the valve returns to its sealed position.

According to a preferred forth step of the present method, the gas jet is directed towards the object's surface. In certain embodiments, such as those utilizing a portable canister, this step is accomplished by holding the canister at an angle relative to the surface and directing the jet stream toward the surface at a distance to provide sufficient motive force so as to dislodge, and preferably expels or blow away, at least a portion of the particulate on the surface. This step may be preformed iteratively in order to remove a larger portion of the particulate matter from the surface to be cleaned.

What is claimed is:

1. A dusting apparatus comprising a pressurized fluid and a mechanism for converting said pressurized fluid into a gas jet, wherein said pressurized fluid comprises at least one of 1,1,1,3,3-pentafluoropropane and trans-1,3,3,3-tetrafluoropropene.

2. A dusting apparatus comprising a pressurized fluid and a mechanism for converting said pressurized fluid into a gas jet, wherein said pressurized fluid is selected from the group consisting of 1,1,1,3,3-pentafluoropropane, trans-1,3,3,3-tetrafluoropropene, and blends containing a major portion of 1,1,1,3,3-pentafluoropropane, trans-1,3,3,3-tetrafluoropropene, or both.

3. The dusting apparatus of claim 1 wherein said pressurized fluid has a vapor pressure of from about 18 to about 65 psia at 70° F.

4. The dusting apparatus of claim 1 wherein said pressurized fluid consists essentially of 1,1,1,3,3-pentafluoropropane.

5. The dusting apparatus of claim 1 wherein said pressurized fluid consists essentially of trans-1,3,3,3-tetrafluoropropene.

6. The dusting apparatus of claim 2 wherein said blends further comprises 1,1,1,2-tetrafluoroethane, 1,1-difluoroethane, and combinations thereof.

7. The dusting apparatus of claim 6 wherein said pressurized fluid consists essentially of 1,1,1,3,3-pentafluoropropane and at least one of 1,1,1,2-tetrafluoroethane and 1,1-difluoroethane.

8. The dusting apparatus of claim 7 wherein said pressurized fluid comprises from about 80 weight percent to about 99 weight percent of 1,1,1,3,3-pentafluoropropane.

9. The dusting apparatus of claim 8 wherein said pressurized fluid comprises from about 90 weight percent to about 95 weight percent of 1,1,1,3,3-pentafluoropropane.

10. A gas jet apparatus comprising:
a sealed canister;
a valve system; and
pressurized fluid having a vapor pressure of from about 20 to about 40 psia at 70° F.;
wherein said pressurized fluid is selected from the group consisting of 1,1,1,3,3-pentafluoropropane, trans-1,3,3,3-tetrafluoropropene, and blends containing a major portion of 1,1,1,3,3-pentafluoropropane, trans-1,3,3,3-tetrafluoropropene, or both.

11. The gas jet apparatus of claim 10 wherein said pressurized fluid consists essentially of 1,1,1,3,3-pentafluoropropane.

12. The gas jet apparatus of claim 10 wherein said pressurized fluid is a blend of 1,1,1,3,3-pentafluoropropane and at least one additional hydrofluorocarbon.

13. The gas jet apparatus of claim 12 wherein said pressurized fluid is a blend of 1,1,1,3,3-pentafluoropropane and another hydrofluorocarbon selected from the group consisting of 1,1,1,2-tetrafluoroethane, 1,1-difluoroethane, and combinations thereof.

14. The gas jet apparatus of claim 13 wherein said pressurized fluid is a mixture of 1,1,1,3,3-pentafluoropropane and 1,1,1,2-tetrafluoroethane, having a pressure from about 20 to about 30 psia at 70° F.

15. The gas jet apparatus of claim 10, wherein a portion of said pressurized fluid is liquid.

16. A method of removing a particulate substance from a surface of a object comprising the steps of:
(a) providing an object having a surface, wherein upon said surface there is a particulate substance;
(b) providing a fluid comprising at least one of 1,1,1,3,3-pentafluoropropane and trans-1,3,3,3-tetrafluoropropene, at a pressure higher than atmospheric pressure;
(c) producing a gas jet from said pressurized fluid; and
(d) directing said gas jet towards said surface.

17. The method of claim 16 wherein said pressurized fluid is selected from the group consisting of 1,1,1,3,3-pentafluoropropane, trans-1,3,3,3-tetrafluoropropene, and blends containing a major portion of 1,1,1,3,3-pentafluoropropane, trans-1,3,3,3-tetrafluoropropene, or both.

18. The method of claim 17 wherein said pressurized fluid is essentially trans-1,3,3,3-tetrafluoropropene.

19. The method of claim 17 wherein said pressurized fluid is essentially 1,1,1,3,3-pentafluoropropane.

20. The method of claim 17 wherein said pressurized fluid is a mixture of 1,1,1,3,3-pentafluoropropane and another hydrofluorocarbon.

21. The method of claim 20 wherein said pressurized fluid is a mixture of 1,1,1,3,3-pentafluoropropane and another hydrofluorocarbon selected from the group consisting of 1,1,1,2-tetrafluoroethane, 1,1-difluoroethane, and combinations thereof.

22. The method of claim 21 wherein said pressurized fluid is a mixture of 1,1,1,3,3-pentafluoropropane and 1,1,1,2-tetrafluoroethane, having a pressure from about 20 to about 30 psia at 70° F.

23. The method of claim 16 wherein said particulate matter is selected from the group consisting of lint, dust, metallic oxide deposits, sand, soil, or a combination of two or more thereof.
